(19) United States
(12) Patent Application Publication
(10) Pub. No.: US 2011/0303066 A1
(43) Pub. Date: Dec. 15, 2011

(54) CUTTING APPARATUS WITH A PAIR OF COUNTER-ROTATING SAW BLADES

(76) Inventor: Yuedui LI, Zhejiang (CN)

(21) Appl. No.: 12/848,955

(22) Filed: Aug. 2, 2010

(30) Foreign Application Priority Data
Jun. 11, 2010 (CN) 2010202199445

(51) Int. Cl. B23D 45/10

(52) U.S. Cl. 83/499

(57) ABSTRACT

A cutting apparatus comprising: a first blade comprising a first surface; and a second blade comprising a second surface, wherein the first surface is positioned to face the second surface and wherein the distance between the first surface and the second surface increase from an outer edge of the cutting apparatus toward the center of the cutting apparatus.

### CROSS-REFERENCE TO RELATED APPLICATIONS

This application claims priority under 35 USC §119 to CN2010202199445, filed on Jun. 11, 2010, to inventor Yuedui Li, titled “Cutting Apparatus with a Pair of Counter-rotating Saw Blades,” the contents of which are incorporated herein by reference in their entirety.

### FIELD OF THE INVENTION

This disclosure generally relates to the field of cutting tools and, more particularly, to electrically-driven circular saws with a pair of counter-rotating blades.

### BACKGROUND OF THE INVENTION

Electrically-driven circular saws are well-known and used in a variety of applications. Some circular saws employ one blade rotating in a single direction, which limits these circular saws to cutting in one direction only. Such saws engender a large reactionary force and are not easy to handle. As a result, they are inappropriate for cutting hard materials, such as steel.

It is known that the use of a pair of counter-rotating blades is more efficient in hard material applications. Typically, the blades are positioned by steps, which requires a high degree of precision. Thus, known double-blade circular saws are costly to manufacture. Further, known double-blade circular saws generate high temperatures when used, which results in deformation of the saw blades at the teeth. As a result, the blades become misaligned and the saw loses it efficacy. Thus, traditional double-blade circular saws can be unreliable.

In light of the above deficiencies in the prior art, what is needed is a circular saw which is effective for cutting hard materials, is reliable, and does not require a high degree of precision to align.

### SUMMARY OF THE INVENTION

The invention provides cutting apparatuses which are effective for cutting hard materials, are reliable, and do no require a high degree of precision to align. In one embodiment, a cutting apparatus includes a first blade and a second blade. The first blade is positioned to face the second blade and the distance between the blades increases from an outer edge of the cutting apparatus toward the center of the cutting apparatus. In some embodiments, the narrowest distance between the blades is between approximately 0.005 and 0.15 mm. In some embodiments the angles between the blades is between approximately 1° and 3°.

In a further embodiment, the first blade is coupled to a first sleeve and the second blade is coupled to a second sleeve. In this embodiment, the distance between the first blade and the second blade is controlled by controlling the distance between the first sleeve and the second sleeve.

In yet a further embodiment, each sleeve comprises a protrusion which is configured to couple to a recess on the corresponding blade to ensure correct coupling of the blades and sleeves.

### BRIEF DESCRIPTION OF THE DRAWINGS

FIG. 1 is a cross-sectional side view of a cutting apparatus with a pair of counter-rotating saw blades in accordance with an embodiment of the invention.

FIG. 2 is a top view of a blade in accordance with an embodiment of the invention.

### DETAILED DESCRIPTION OF EXEMPLARY EMBODIMENTS

In the following description of exemplary embodiments, reference is made to the accompanying drawings which form a part hereof, and in which it is shown by way of illustration, specific exemplary embodiments in which the invention can be practiced. It is to be understood that other embodiments can be used and structural changes can be made without departing from the spirit and scope of the invention.

Disclosed herein are cutting apparatus which use two blades which are separated by varying distance from the outer edge of the apparatus toward the center. The embodiments of the present invention have the benefits of a reduced precision requirement, simplified processing, improved reliability, and reduced processing costs.

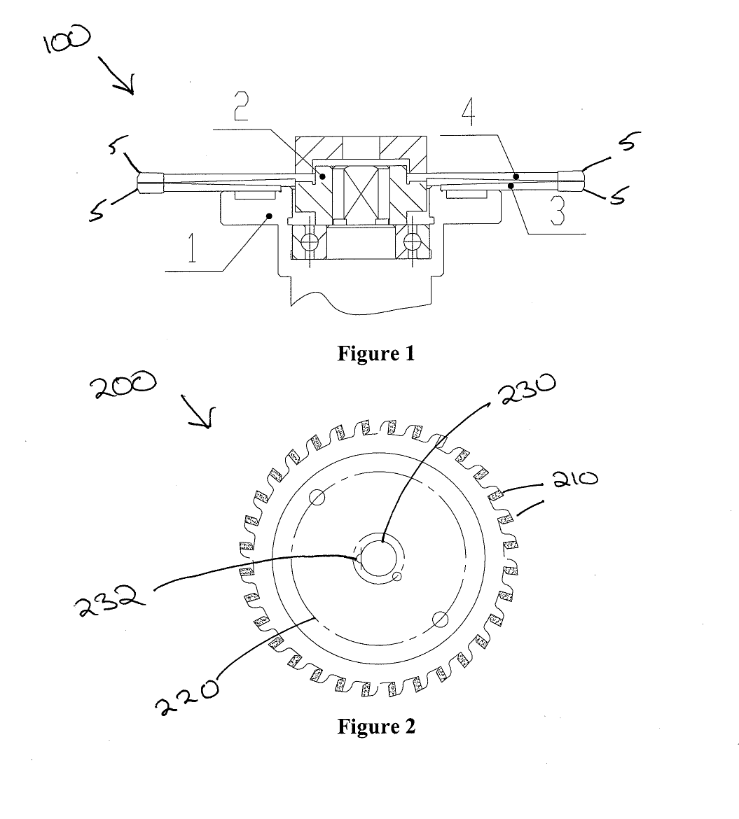

FIG. 1 is a cross-sectional side view of a cutting apparatus 100 with a pair of counter-rotating saw blades in accordance with an embodiment of the invention. Cutting apparatus 100 includes outer sleeve 1, inner sleeve 2, outer saw blade 3, and inner saw blade 4. Each blade further includes teeth 5.

In one embodiment, outer saw blade 3 is mounted on outer sleeve 1 and inner saw blade 4 is mounted on inner sleeve 2. Outer saw blade 3 and inner saw blade 4 rotate in opposite directions. In some embodiments, inner sleeve 2 is coupled to outer sleeve 1 using bearings. However, the sleeves may be otherwise coupled without deviating from the scope of the invention.

In some embodiments, the distance between the surfaces of outer saw blade 3 and the inner saw blade 4 varies, with the saw blades being closest in the region of the teeth 5. In some embodiments, the blades may be conical. However, the blades are not so limited. For effective cutting, the distance between the two saw blades at the location of the teeth should be precise. As an exemplary advantage of the invention, this distance is easily controlled by controlling the distance between the inner and outer sleeves. In some embodiments, this distance is in the range of approximately 0.005-0.15 mm. In comparison to the prior art, this precision requirement is relatively low. In some embodiments, the surfaces between the outer blade and the inner blade form an angle of approximately 1-3°. As a further exemplary advantage to the invention, as blade deformation occurs at the teeth due to high temperatures there, the distance between the blades can be adjusted to maintain efficacy of the circular saw.

FIG. 2 is a top view of a blade 200 in accordance with an embodiment of the invention. Blade 200 comprises a base 220 and teeth 210. Teeth 210 may represent teeth 5, described above in more detail with respect to FIG. 1.

The outer edge of base 220 is coupled to teeth 210. The inner edge 230 of the base 220 comprises an aperture for coupling the base 220 to a sleeve, such as the inner or outer sleeves of FIG. 1 above. Although the base 220 comprises an aperture for coupling, any other means for coupling could be used without departing from the spirit of the invention. In some embodiments, inner edge 230 may comprise a recess to ensure correct coupling of the base 220 to the sleeve. This recess may correlate to a protrusion on the corresponding sleeve.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A cutting apparatus comprising:
a first blade comprising a first surface; and
a second blade comprising a second surface, wherein the first surface is positioned to face the second surface and wherein the distance between the first surface and the second surface increase from an outer edge of the cutting apparatus toward the center of the cutting apparatus.

2. The cutting apparatus of claim 1 further comprising:
a first sleeve coupled to the first blade; and
a second sleeve coupled to the second blade, wherein the distance between the first blade and the second blade is controlled by a distance between the first sleeve and the second sleeve.

3. The cutting apparatus of claim 2, wherein the first sleeve comprises a protrusion which is configured to couple to a recess on the first blade to ensure correct coupling of the first blade to the first sleeve.

4. The cutting apparatus of claim 3, wherein the second sleeve comprises a protrusion which is configured to couple to a recess on the second blade to ensure correct coupling of the second blade to the second sleeve.

5. The cutting apparatus of claim 4, wherein the narrowest distance between the first blade and the second blade is between 0.005 and 0.15 mm.

6. The cutting apparatus of claim 4, wherein the angle between the first surface and the second surface is between 1° and 3°.

7. The cutting apparatus of claim 1, wherein the narrowest distance between the first blade and the second blade is between 0.005 and 0.15 mm.

8. The cutting apparatus of claim 1, wherein the angle between the first surface and the second surface is between 1° and 3°.

9. The cutting apparatus of claim 1, wherein the first and second blades are conical.
